(19) United States
(12) Patent Application Publication
(10) Pub. No.: US 2020/0026914 A1
(43) Pub. Date: Jan. 23, 2020

(54) INFORMATION PROCESSING DEVICE, INFORMATION PROCESSING METHOD, AND INFORMATION PROCESSING SYSTEM FOR EXTRACTING INFORMATION ON ELECTRONIC PAYMENT FROM BILL IMAGE

(71) Applicant: KYOCERA Document Solutions Inc., Osaka (JP)

(72) Inventor: Paul Mark PUNZALAN, Osaka (JP)

(73) Assignee: KYOCERA Document Solutions Inc., Osaka (JP)

(21) Appl. No.: 16/456,994

(22) Filed: Jun. 28, 2019

(30) Foreign Application Priority Data
Jul. 18, 2018 (JP) 2018-135330
Apr. 19, 2019 (JP) 2019-080452

(51) Int. Cl. G06K 9/00; G06K 9/34

(52) U.S. Cl. CPC G06K 9/00469; G06K 9/00449; G06K 2209/01; G06K 9/344; G06K 9/00463

(57) ABSTRACT

An information processing device includes a display section, a control unit, an operating section, and a communication section. The control unit functions as: an identification information extracting section that extracts, from a bill image, identification information indicating a demander; a type determination section that determines a type of bill associated with the identification information; a region identifying section that identifies, based on a format associated with the type of bill determined by the type determination section, a region of the bill image containing character images related to an electronic payment; a payment information extracting section that extracts characters related to the electronic payment from the region; and a display control section that allows the display section to display the characters related to the electronic payment. When the operating section accepts an instruction to make settlement, the communication section sends to a settlement server the characters related to the electronic payment.

### INCORPORATION BY REFERENCE

This application claims priority to Japanese Patent Application No. 2018-135330 filed on Jul. 18, 2018 and No. 2019-080452 filed on Apr. 19, 2019, the entire contents of which are incorporated by reference herein.

### BACKGROUND

The present disclosure relates to information processing devices, information processing methods, and information processing systems and particularly relates to a technique for processing an acquired image of a bill to extract information on an electronic payment, outputting the information to a settlement server, and allowing the electronic payment to be made on the settlement server.

In a general settlement system including a mobile phone, an application server, and a settlement server, the mobile phone reads and decodes a bar code on a bill and sends decoded data on the bar code to the application server, the application server generates, from the decoded data on the bar code, information for making settlement and sends the information to the settlement server, and the settlement server sends a result of its settlement processing back to the mobile phone and the application server, thus completing an electronic payment with a credit card.

### SUMMARY

A technique improved over the above technique is proposed as one aspect of the present disclosure.

An information processing device according to an aspect of the present disclosure includes a display section, a format storage section, a control unit, an operating section, and a communication section. The format storage section previously stores formats of bills for individual types of bill. The control unit includes a processor and, upon execution of a control program by the processor, functions as an image acquisition section, an identification information extracting section, a type determination section, a region identifying section, a character recognition section, a payment information extracting section, and a display control section. The image acquisition section acquires a bill image which is an image of a bill charged to a user. The identification information extracting section extracts, from the bill image acquired by the image acquisition section, identification information indicating a demander. The type determination section determines a type of bill associated with the identification information extracted by the identification information extracting section. The region identifying section reads from the format storage section a format associated with the type of bill determined by the type determination section and identifies, based on the read format of the bill, a region of the bill image containing character images related to an electronic payment. The character recognition section recognizes characters in the region identified by the region identifying section. The payment information extracting section extracts, among the characters in the region recognized by the character recognition section, characters related to the electronic payment. The display control section allows the display section to display the electronic payment-related characters extracted by the payment information extracting section. The operating section accepts from the user an instruction to make settlement with contents of the electronic payment displayed on the display section. The communication section sends to a settlement server the electronic payment-related characters when the operating section accepts the instruction to make settlement.

An information processing method according to another aspect of the present disclosure includes an image acquisition step, an identification information extracting step, a type determination step, a region identifying step, a character recognizing step, a payment information extracting step, a display control step, an operating step, and a communication step. In the image acquisition step, a bill image which is an image of a bill charged to a user is acquired. In the identification information extracting step, identification information indicating a demander is extracted from the bill image acquired in the image acquisition step. In the type determination step, a type of bill associated with the identification information extracted in the identification information extracting step is determined. In the region identifying step, a format associated with the type of bill determined in the type determination step is read from a format storage section previously storing formats of bills for individual types of bill, and a region of the bill image containing character images related to an electronic payment is identified based on the read format of the bill. In the character recognizing step, characters in the region identified in the region identifying step are recognized. In the payment information extracting step, among the characters in the region recognized in the character recognizing step, characters related to the electronic payment are extracted. In the display control step, a display section is allowed to display the electronic payment-related characters extracted in the payment information extracting step. In the operating step, an instruction from the user to make settlement with contents of the electronic payment displayed on the display section is accepted. In the communication step, upon acceptance of the instruction to make settlement in the operating step, the electronic payment-related characters are sent to a settlement server.

An information processing system according to still another aspect of the present disclosure is an information processing system in which an information processing device and a settlement server are capable of communication with each other via a network, and the information processing device includes a control unit and a communication section. The control unit includes a processor and, upon execution of a control program by the processor, functions as an image acquisition section and an identification information extracting section. The image acquisition section acquires a bill image which is an image of a bill charged to a user. The identification information extracting section extracts, from the bill image acquired by the image acquisition section, identification information indicating a demander. The communication section sends to the settlement server the identification information extracted by the identification information extracting section. The settlement server includes a format storage section, a server control unit, and a server communication section. The format storage section previously stores formats of bills for individual types of bill. The server control unit includes a processor and, upon execution of a server control program by the processor, functions as a type determination section and a region identifying section. The type determination section determines a type of bill associated with the identification information having been extracted by the identification information extracting section and having been received from the communication section. The region identifying section reads from the format storage section a format associated with the type of bill determined by the type determination section and identifies, based on the read format of the bill, a region of the bill image containing character images related to an electronic payment. The server communication section sends to the information processing device the region identified by the region identifying section. The information processing device further includes a display section and an operating section. The control unit further functions as, upon execution of the control program by the processor, a character recognition section, a payment information extracting section, and a display control section. The character recognition section recognizes characters in the region sent from the server communication section and received by the communication section. The payment information extracting section extracts, among the characters in the region recognized by the character recognition section, characters related to the electronic payment. The display control section allows the display section to display the electronic payment-related characters extracted by the payment information extracting section. The operating section accepts from the user an instruction to make settlement with contents of the electronic payment displayed on the display section. The communication section sends the electronic payment-related characters to the settlement server when the operating section accepts the instruction to make settlement. The settlement server settles the electronic payment based on information indicated by the electronic payment-related characters sent from the communication section and received by the server communication section.

### BRIEF DESCRIPTION OF THE DRAWINGS

FIG. 1 is a front view of an information terminal which is an example of an information processing device according to an embodiment of the present disclosure.

FIG. 2 is a block diagram showing an internal configuration of the information terminal in an information processing system according to a first embodiment.

FIG. 3 is a view showing an example of a correspondence storage table representing the correspondence relation between each piece of identification information and the associated type of bill.

FIG. 4 is a flowchart showing an example of electronic payment processing according to the first embodiment.

FIG. 5A is a view showing an example of a bill image.

FIG. 5B is a view showing an example of the information terminal in which extracted electronic payment-related characters are displayed on a display section.

FIG. 6A is a view showing examples of images of the electronic payment-related characters contained in the bill image.

FIG. 6B is a view showing an example in which an identification image in the bill image has been extracted.

FIG. 7 is a block diagram showing respective internal configurations of an information terminal and a settlement server in an information processing system according to a second embodiment.

### DETAILED DESCRIPTION

Hereinafter, a description will be given in detail of an information processing device and an information processing system both according to an embodiment of the present disclosure with reference to the drawings.

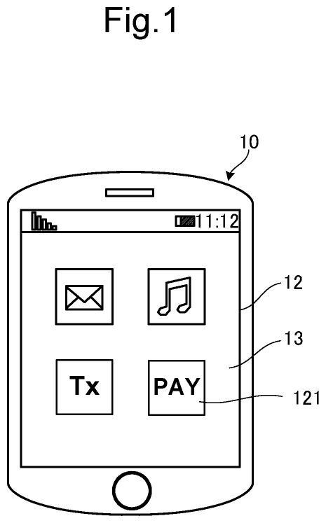

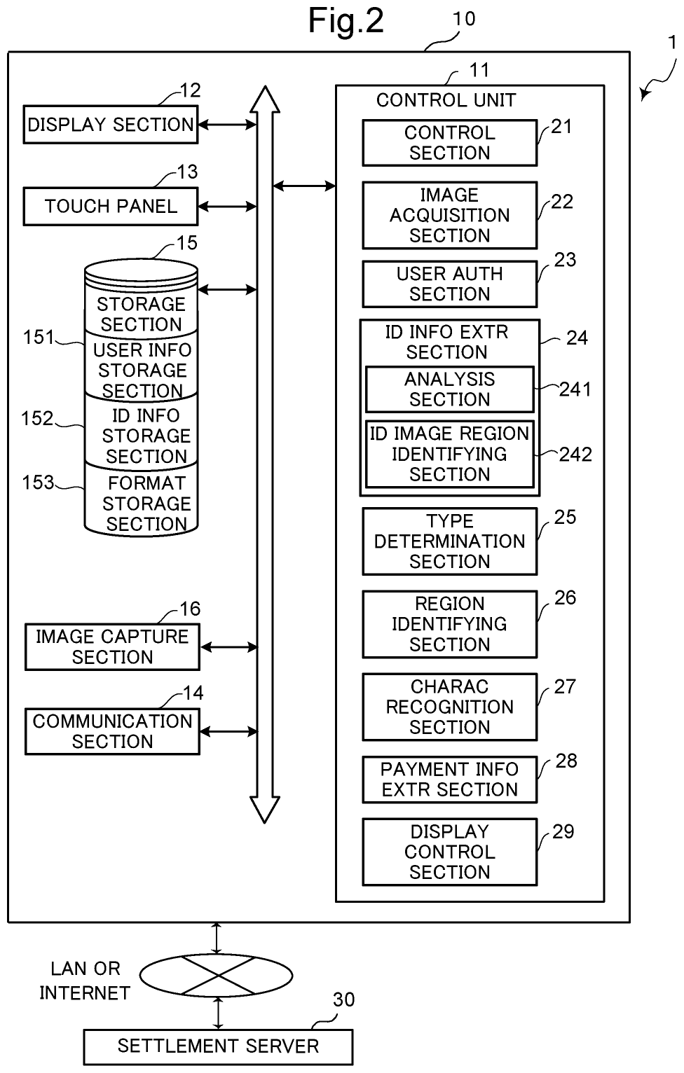

FIG. 1 is a front view of an information terminal which is an example of an information processing device according to an embodiment of the present disclosure. FIG. 2 is a block diagram showing an internal configuration of the information terminal in an information processing system according to a first embodiment.

The information processing system 1 according to the first embodiment includes an information terminal 10 and a settlement server 30. The information terminal 10 and the settlement server 30 are communicably connected to each other via a network.

An electronic payment application provided by the settlement server 30 is already installed on the information terminal 10. When the information terminal 10 runs the electronic payment application, the function of generating characters related to an electronic payment from a bill image and sending them to the settlement server 30, the function of receiving a result of the electronic payment from the settlement server 30, and so on are built on the information terminal 10.

The settlement server 30 is a server that provides the electronic payment application to the information terminal 10, provides an electronic payment service to the information terminal 10 running the electronic payment application, and settles the electronic payment. For example, the settlement server 30 settles a payment by withdrawal from a bank account or a postal savings account, a payment by a credit card, or a payment by e-money.

The information terminal 10 is, for example, a mobile terminal, such as a tablet computer, and includes a control unit 11, a display section 12, a touch panel 13, a communication section 14, a storage section 15, and an image capture section 16. These components can transfer data or signals to and from one another via a bus.

The display section 12 is formed of a liquid crystal display (LCD), an organic EL (organic light-emitting diode (OLED)) display or the like.

The touch panel 13 is a touch panel of, for example, a so-called resistive film system or a capacitance system. The touch panel 13 is disposed on the screen of the display section 12 and is capable of detecting a touch on the screen of the display section 12 with a finger or the like, together with the point of touch. When detecting a touch with a finger or the like, the touch panel 13 outputs a detection signal indicating the coordinate of the point of touch to a control section 21 of the control unit 11 or the like. Therefore, the touch panel 13 serves as an operating section through which a user's operation made on the screen of the display section 12 is input.

The information terminal 10 may also include, in addition to the above touch panel 13, hard keys as an operating section through which a user's operation is to be input.

The communication section 14 is a communication interface including a communication module, such as an unshown LAN chip. The communication section 14 has various communication functions, such as an e-mail communication function and the function of communicating with the settlement server 30. For example, the communication section 14 is capable of receiving a bill image in PDF (portable document format) attached to an e-mail.

The storage section 15 is formed of a large-storage SSD (solid state drive), HDD (hard disk drive) or the like and stores various types of data and programs. Furthermore, the storage section 15 includes a user information storage section 151, an identification information storage section 152, and a format storage section 153.

The user information storage section 151 previously stores credentials of each user and personal information on the user in association with each other. The user's credentials are composed of: a user ID (login name) as a user-specific identification code necessary for the user to log in as a qualified person to the electronic payment application to be started on the information terminal 10; and a password. The personal information on the user is personal information previously registered by the user and includes characters of the name (for example, XYZ Bank) of a bank where the user has an account, characters of an account holder, characters of an account number, characters of a mobile phone number of the user, and so on.

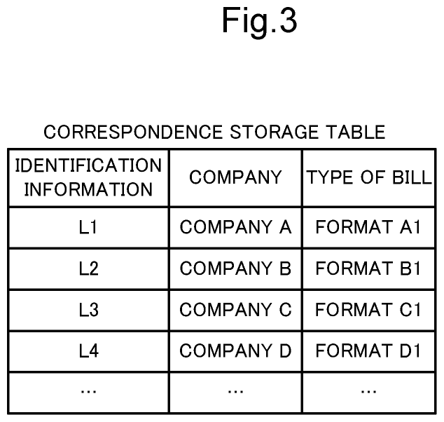

The identification information storage section 152 previously stores identification information indicating each demander, such as a bank or a credit company. For example, as shown in FIG. 3, the identification information storage section 152 stores company logos L1, L2, L3, L4, . . . as respective pieces of identification information indicating demanders and also stores, in association with the company logos L1, L2, L3, L4, . . . , respective companies which are the demanders indicated by the logos. For example, a logo L1 indicates Company A (specifically, Company A is ABC Bank) and a logo L2 indicates Company B.

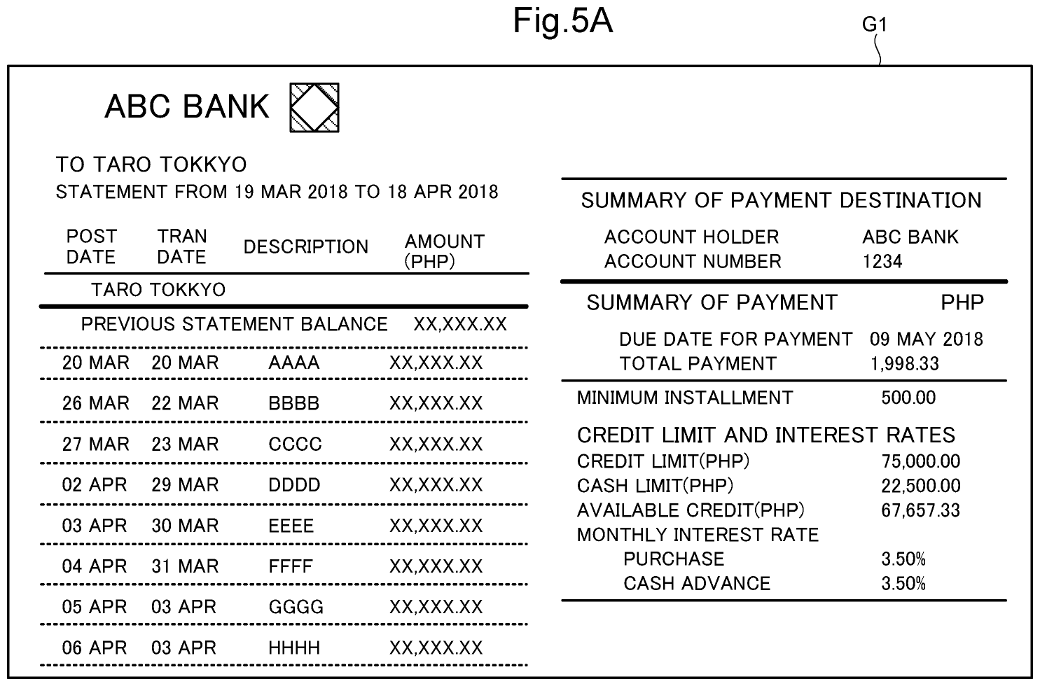

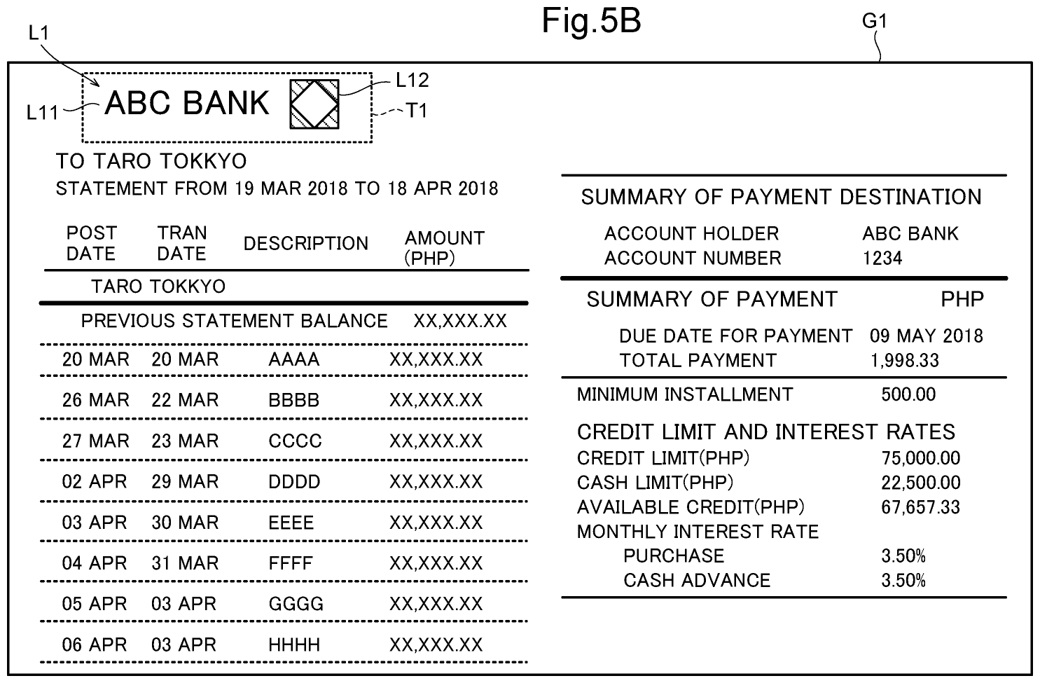

For example, as shown in FIG. 5B to be described hereinafter, the logo L1 includes: a company logo L11 in which the company's name (in this case, the name of ABC Bank) is expressed by normal characters; and a symbol L12 representing the company (in this case, ABC Bank). The identification information is not limited to a logo and may contain at least one of a symbol, a company logo, and a symbolic logo formed of stylized characters of the company's name.

The format storage section 153 previously stores formats of bills for individual types of bill. For example, the types of bill differ with each company as a demander. As shown in FIG. 3, the format storage section 153 stores formats of bills for individual companies as demanders. The format storage section 153 stores a format A1 of a bill for Company A (ABC Bank), a format B1 of a bill for Company B, a format Cl of a bill for Company C, and a format D1 of a bill for Company D.

The image capture section 16 is, for example, a camera. The image capture section 16 captures an image of a bill to the user according to a user's operation.

The control unit 11 is composed of a processor, a RAM (random access memory), a ROM (read only memory), and so on. The processor is, for example, a CPU (central processing unit), an MPU or an ASIC. When a control program stored in the above ROM or storage section 15 is executed by the above processor, the control unit 11 functions as a control section 21, an image acquisition section 22, a user authenticating section 23, an identification information extracting section 24, a type determination section 25, a region identifying section 26, a character recognition section 27, a payment information extracting section 28, and a display control section 29. Alternatively, each of these sections of the control unit 11 may not be implemented by the operation of the control unit 11 in accordance with the above control program but may be constituted by a hardware circuit.

The control section 21 governs the overall operation control of the information terminal 10. Furthermore, the control section 21 is connected to the display section 12, the touch panel 13, the communication section 14, the storage section 15, the image capture section 16, and so on and performs operation control of these components and signal or data transfer to and from each of these components.

Moreover, the control section 21 identifies a user's operation input by the user, based on a detection signal output from the touch panel 13. An example of the user's operation is a touch gesture (tap gesture). The control section 21 performs control according to the identified user's operation. For example, when the user makes a touch gesture on an icon (graphic image) 121 displayed on the screen of the display section 12 shown in FIG. 1 and representing the electronic payment application, a detection signal indicating the coordinate of the point of touch and indicating the touch gesture is output to the control section 21 by the touch function of the touch panel 13 and the control section 21 then runs the electronic payment application based on the detection signal. By performing an operation and so on according to the electronic payment application, it is possible to generate characters related to an electronic payment from a bill image and send them. Details thereof will be described later.

The user authenticating section 23 determines whether or not input information for user authentication input on the touch panel 13 agrees with the credentials stored in the user information storage section 151. Specifically, at the start of the electronic payment application run by the control section 21, the display control section 29 allows the display section 12 to display a screen image prompting the user to input a user ID (login name) and a password and the information terminal 10 waits for input information to be input. When the input information for user authentication is input on the touch panel 13, the user authenticating section 23 determines whether or not the input information agrees with the credentials stored in the user information storage section 151.

The image acquisition section 22 acquires a bill image which is an image of a bill charged to the user. When the user authenticating section 23 determines that the input information agrees with the credentials, the image acquisition section 22 acquires a bill image captured by the image capture section 16 or a bill image attached to an e-mail received by the communication section 14.

Specifically, when the user authenticating section 23 determines that the input information agrees with the credentials, the image capture section 16 is permitted to capture an image of the bill charged to the user. Then, the image capture section 16 captures an image of the bill to the user according to a user's operation. Then, the image acquisition section 22 acquires the bill image captured by the image capture section 16 and allows the storage section 15 to store the bill image. Alternatively, when the user authenticating section 23 determines that the input information agrees with the credentials and if a bill image is attached to an e-mail received by the communication section 14, the image acquisition section 22 acquires the bill image and allows the storage section 15 to store the bill image.

The identification information extracting section 24 extracts, from the bill image acquired by the image acquisition section 22, identification information indicating a demander. For example, the identification information extracting section 24 includes, as shown in FIG. 2, an analysis section 241 that analyzes the layout of the bill image acquired by the image acquisition section 22, and an identification image region identifying section 242 that identifies an identification image region containing an identification image representing the identification information in the bill image the layout of which has been analyzed by the analysis section 241. The identification information extracting section 24 subjects the identification image region identified by the identification image region identifying section 242 to image recognition or character recognition, thus extracting the identification information represented by the identification image.

For example, the analysis section 241 analyzes the layout of a bill image G1 shown in FIG. 5A. The identification image region identifying section 242 identifies, in the bill image G1 subjected to the layout analysis by the analysis section 241 and shown in FIG. 5B, an identification image region T1 containing an identification image (a logo L1 consisting of a company logo L11 and a symbol L12) representing identification information. Then, the identification information extracting section 24 subjects the identification image region T1 identified by the identification image region identifying section 242 to image recognition or character recognition, thus extracting the identification information (ABC Bank and its symbol) represented by the identification image (the company logo L11 and the symbol L12). In this embodiment, both of the company logo L11 and the symbol L12 are extracted. However, they indicate the same company and, therefore, either one of them may be extracted. Also in this case, a demander of the bill, i.e., the company, can be identified.

The type determination section 25 determines the type of bill associated with the identification information extracted by the identification information extracting section 24. As shown in FIG. 3, pieces of identification information, respective associated company's names, and respective associated types of bill are previously stored in the form of a correspondence storage table. Specifically, the type determination section 25 uses the correspondence storage table shown in FIG. 3 to determine, if the identification information extracted by the identification information extracting section 24 is the logo L1, that the logo L1 indicates Company A (ABC Bank) and the type of bill associated with Company A (ABC Bank) is a format A1.

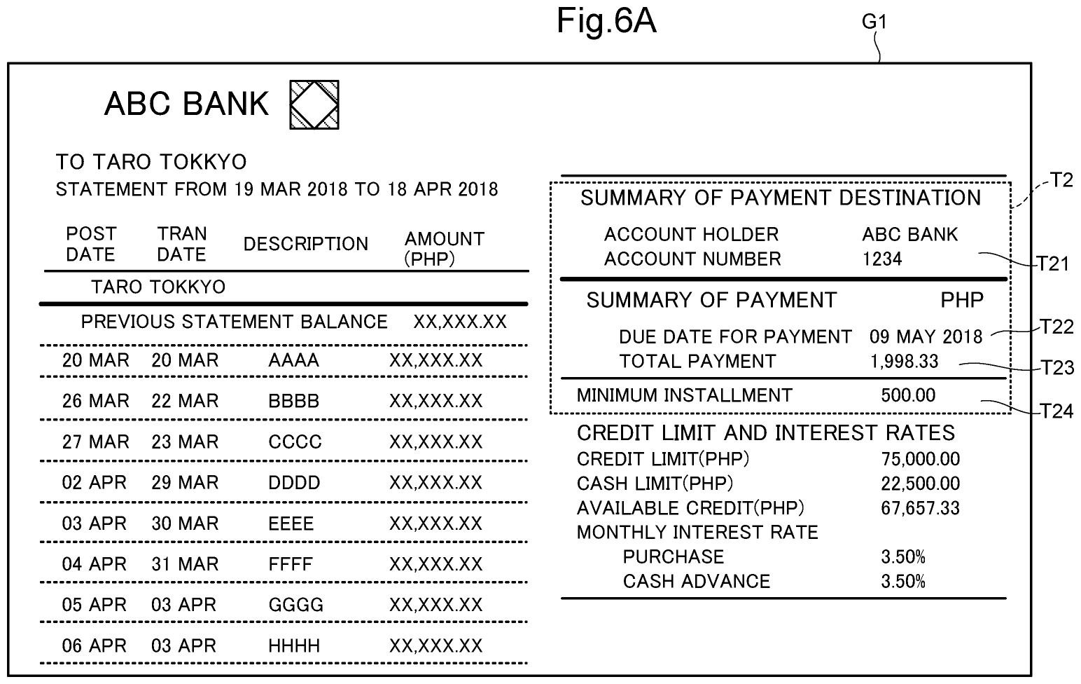

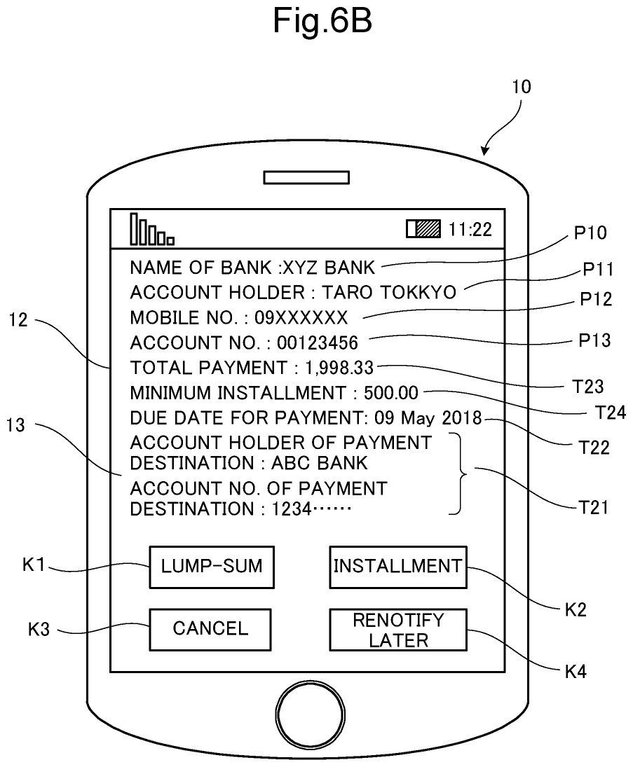

The region identifying section 26 reads from the format storage section 153 a format associated with the type of bill determined by the type determination section 25 and identifies, based on the read format of the bill, a region of the bill image containing character images related to an electronic payment. For example, when the format associated with the type of bill determined by the type determination section 25 is the format A1 shown in FIG. 3, the region identifying section 26 reads the format A1 of the bill for Company A (ABC Bank) from the format storage section 153. Then, the region identifying section 26 identifies, based on the read format A1 of the bill, a region T2 of the bill image G1 containing character images related to an electronic payment as shown in FIG. 6A to be described later. The format A1 contains layout information on the region T2 of the bill image G1. Therefore, the region identifying section 26 uses the layout information contained in the format A1 of the bill to identify the region T2 of the bill image G1.

The character recognition section 27 recognizes characters in the region identified by the region identifying section 26 (i.e., a region containing character images related to an electronic payment). For example, the character recognition section 27 subjects the region T2 shown in FIG. 6A to known OCR (optical character recognition) processing to recognize characters in the region T2.

The payment information extracting section 28 extracts, among the characters in the region recognized by the character recognition section 27, characters related to an electronic payment. For example, as shown in FIG. 6A, the payment information extracting section 28 extracts, among characters in the region T2 recognized by the character recognition section 27, as characters related to an electronic payment, characters T21 indicating an account holder and an account number of a demander's account with a bank (i.e., a payment destination), characters T22 indicating the term “due date for payment” and the due date, characters T23 indicating the term “total payment” and the amount, and characters T24 indicating the term “minimum installment”, which is an example of the amount of installment, and the amount.

Furthermore, the payment information extracting section 28 acquires, from the user's personal information stored in the user information storage section 151, at least the characters P10 of the name of a bank (for example, XYZ Bank) where the user has an account, the characters P11 of an account holder, and the characters P13 of an account number. In this embodiment, from the user's personal information stored in the user information storage section 151, the payment information extracting section 28 further acquires the characters P12 of a mobile phone number of the user.

The display control section 29 controls, under the control of the control section 21, the display operation of the display section 12. Furthermore, the display control section 29 allows the display section 12 to display the electronic payment-related characters extracted by the payment information extracting section 28. For example, as shown in FIG. 6B, the display control section 29 allows the display section 12 to display, as the electronic payment-related characters extracted by the payment information extracting section 28, the characters T21 indicating an account holder and an account number of a demander's account with a bank, the characters T22 indicating the term “due date for payment” and the due date, the characters T23 indicating the term “total payment” and the amount, and the characters T24 indicating the term “minimum installment” and the amount. Moreover, as shown in FIG. 6B, the display control section 29 allows the display section 12 to display, as the user's personal information stored in the user information storage section 151, the characters P10 of the name of a bank where the user has an account, the characters P11 of an account holder of the account, the characters P12 of a user's mobile phone number, and the characters P13 of a user's account number.

The touch panel 13 accepts from the user an instruction to make settlement with the contents of the electronic payment displayed on the display section 12.

The communication section 14 sends to the settlement server 30 the electronic payment-related characters when the touch panel 13 accepts the instruction to make settlement.

The settlement server 30 settles an electronic payment based on the received electronic payment-related characters. For example, the settlement server 30 identifies, from the received electronic payment-related characters, more specifically from the characters P10 of the name of a bank (for example, XYZ Bank) where the user has an account, the characters P11 of an account holder, and the characters P13 of an account number, the name of a bank for the user, an account holder of the user's account, and a user's account number. Furthermore, the settlement server 30 identifies the name of a payment destination, an account holder of the payment destination, and an account number of the payment destination from the characters T21 indicating an account holder and an account number of a demander's account with a bank, identifies the amount of payment from the characters T23 indicating the term “total payment” and the amount or the characters T24 indicating the term “minimum installment” and the amount, and confirms, from the characters T22 indicating the term “due date for payment” and the due date, that the settlement date of the electronic payment is before the due date. The settlement server 30 settles the electronic payment by withdrawing an amount of payment specified by the user from the bank (for example, XYZ Bank) where the user has an account, and paying the amount of payment to the demander (for example, ABC Bank). Then, the settlement server 30 sends the result of the electronic payment to the communication section 14 of the information terminal 10. Under the control of the control section 21, the display control section 29 of the information terminal 10 allows the display section 12 to display the result of the electronic payment received by the communication section 14.

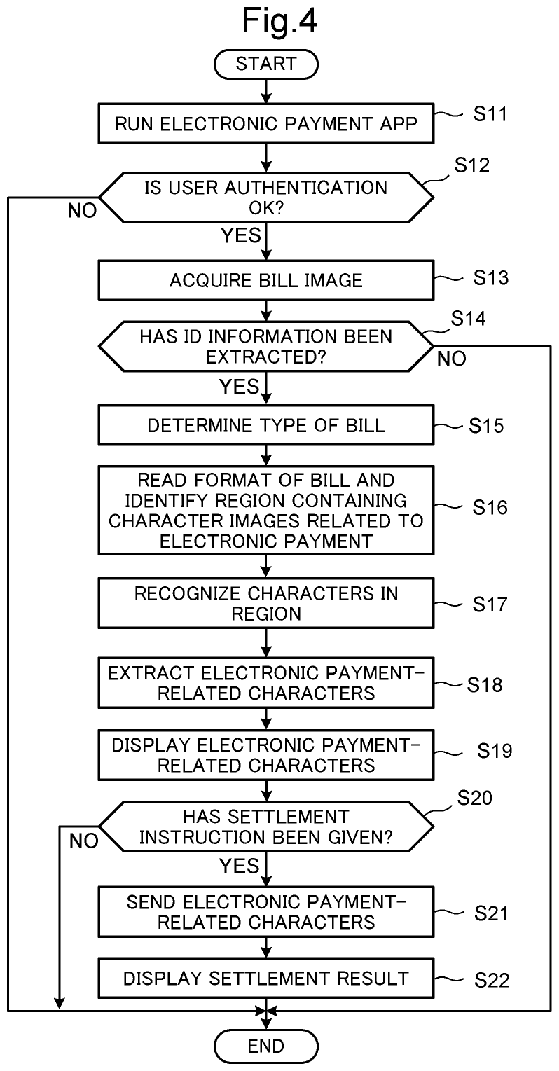

Next, a description will be given of electronic payment processing for generating electronic payment-related characters from an acquired user's bill image and sending them on the information terminal 10 according to the first embodiment, with reference to the flowchart shown in FIG. 4 and so on.

First, when on the information terminal 10 the user makes a touch gesture on an icon 121 representing the electronic payment application on the display section 12 shown in FIG. 1, this gesture is detected by the touch function of the touch panel 13 and the control section 21 then runs the electronic payment application based on the detection signal from the touch panel 13 (S11).

At the start of the electronic payment application run by the control section 21, the display control section 29 allows the display section 12 to display a screen image prompting the user to input a user ID (login name) and a password and the information terminal 10 waits for input information to be input. When a user ID (login name) and a password are input as input information for user authentication to the touch panel 13, the user authenticating section 23 determines whether or not the input user ID (login name) and password agree with a legitimate user ID (login name) and a legitimate password which are credentials stored in the user information storage section 151 (S12: a user authentication step).

When the user authenticating section 23 determines that the input information does not agree with the credentials (“NO” in S12), the control section 21 ends this processing. Specifically, because a login by the user himself/herself has not been confirmed, the control section 21 prematurely terminates the electronic payment processing without acquiring a bill image.

On the other hand, when the user authenticating section 23 determines that the input information agrees with the credentials (“YES” in S12), the image acquisition section 22 acquires a bill image (S13: an image acquisition step). For example, when the user authenticating section 23 determines that the input information agrees with the credentials (“YES” in S12), the image capture section 16 is permitted to capture an image of a bill charged to the user. Then, the image capture section 16 captures an image of the bill to the user according to a user's operation. Then, the image acquisition section 22 acquires the bill image captured by the image capture section 16 and allows the storage section 15 to store the bill image. Here, the image acquisition section 22 acquires a bill image G1 shown in FIG. 5A by image capturing of the bill by the image capture section 16.

However, as an alternative to the acquisition of the bill image from the image capture section 16, the bill image may be acquired from the communication section 14. For example, when the user authenticating section 23 determines that the input information agrees with the credentials and if a bill image is attached to an e-mail received by the communication section 14, the image acquisition section 22 acquires the bill image from the communication section 14.

The identification information extracting section 24 extracts, from the bill image acquired by the image acquisition section 22, identification information indicating a demander (S14: an identification information extracting step). Specifically, the analysis section 241 of the identification information extracting section 24 analyzes the layout of the bill image G1 shown in FIG. 5A. The identification image region identifying section 242 of the identification information extracting section 24 identifies, in the bill image G1 subjected to the layout analysis by the analysis section 241 and shown in FIG. 5B, an identification image region T1 containing an identification image (a company logo L11 and a symbol L12) representing identification information. Then, the identification information extracting section 24 subjects the identification image region T1 identified by the identification image region identifying section 242 to image recognition or character recognition, thus extracting the identification information (ABC Bank and its symbol) represented by the identification image (the company logo L11 and the symbol L12).

For example, when as shown in FIG. 5B the identification information extracting section 24 extracts identification information (“YES” in S14), the type determination section 25 determines the type of bill associated with the identification information extracted by the identification information extracting section 24 (S15: a type determination step). Specifically, the type determination section 25 uses the correspondence storage table shown in FIG. 3 to determine, because the identification information extracted by the identification information extracting section 24 is the logo L1 and the logo L1 indicates Company A (ABC Bank), that the type of bill associated with Company A (ABC Bank) is a format A1.

On the other hand, when in S14 the identification information extracting section 24 fails to extract identification information (“NO” in S14), the control section 21 ends this processing. Specifically, when the identification information extracting section 24 fails to extract identification information, the type of bill cannot be determined and, therefore, the control section 21 prematurely terminates the electronic payment processing.

The region identifying section 26 reads from the format storage section 153 the format associated with the type of bill determined by the type determination section 25 and identifies, based on the read format of the bill, a region of the bill image containing character images related to an electronic payment (S16: a region identifying step). For example, when the format associated with the type of bill determined by the type determination section 25 is the format A1 shown in FIG. 3, the region identifying section 26 reads the format A1 of the bill for Company A (ABC Bank) from the format storage section 153. Then, the region identifying section 26 identifies, based on the read format A1 of the bill, a region T2 of the bill image G1 containing character images related to an electronic payment as shown in FIG. 6A to be described later.

The character recognition section 27 recognizes characters in the region identified by the region identifying section 26 (i.e., a region containing character images related to an electronic payment) (S17: a character recognizing step). For example, the character recognition section 27 subjects the region T2 shown in FIG. 6A to known OCR (optical character recognition) processing to recognize characters in the region T2.

The payment information extracting section 28 extracts, among the characters in the region recognized by the character recognition section 27, characters related to the electronic payment (S18: a payment information extracting step). For example, as shown in FIG. 6A, the payment information extracting section 28 extracts, among characters in the region T2 recognized by the character recognition section 27, as characters related to an electronic payment, characters T21 indicating an account holder and an account number of a demander's account with a bank, characters T22 indicating the term “due date for payment” and the due date, characters T23 indicating the term “total payment” and the amount, and characters T24 indicating the term “minimum installment” and the amount. Furthermore, the payment information extracting section 28 acquires, from the user's personal information stored in the user information storage section 151, the characters P10 of the name of a bank (for example, XYZ Bank) where the user has an account, the characters P11 of an account holder, the characters P12 of a user's mobile phone number, and the characters P13 of a user's account number.

The display control section 29 allows the display section 12 to display the electronic payment-related characters extracted by the payment information extracting section 28 (S19: a display control step). For example, as shown in FIG. 6B, the display control section 29 allows the display section 12 to display, as the electronic payment-related characters extracted by the payment information extracting section 28, the characters T21 indicating an account holder and an account number of a demander's account with a bank, the characters T22 indicating the term “due date for payment” and the due date, the characters T23 indicating the term “total payment” and the amount, and the characters T24 indicating the term “minimum installment” and the amount. Furthermore, as shown in FIG. 6B, the display control section 29 allows the display section 12 to display, as the user's personal information stored in the user information storage section 151, the characters P10 of the name of a bank where the user has an account, the characters P11 of an account holder of the account, the characters P12 of a user's mobile phone number, and the characters P13 of a user's account number.

The control section 21 determines whether there is an instruction to settle the electronic payment (S20). Specifically, the control section 21 determines whether or not the touch panel 13 has accepted from the user an instruction to make settlement with the contents of the electronic payment displayed on the display section 12. When the user makes a touch gesture on a button K1 indicating “Lump-Sum” or a button K2 indicating “Installment” both shown in FIG. 6B and the touch panel 13 detects the touch gesture on the button K1 or button K2, the control section 21 determines, based on a detection signal from the touch panel 13, that there is an instruction to settle the electronic payment.

On the other hand, when the user makes a touch gesture on a button K3 indicating “Cancel” shown in FIG. 6B and the touch panel 13 detects the touch gesture on the button K3 (“NO” in S20), the control section 21 determines, based on a detection signal from the touch panel 13, that there is no instruction to settle the electronic payment. The control section 21 ends this processing.

Alternatively, when the user makes a touch gesture on a button K4 indicating “Renotify Later” and the touch panel 13 detects the touch gesture on the button K4, the control section 21 determines, based on a detection signal from the touch panel 13, that the determination of whether there is an instruction to settle the electronic payment has been suspended.

When the touch panel 13 accepts from the user an instruction to make settlement with the contents of the electronic payment displayed on the display section 12 (“YES” in S20: an operating step), i.e., when there is a touch gesture on the button K1 or button K2 shown in FIG. 6B, the communication section 14 sends the electronic payment-related characters to the settlement server 30 (S21. a communication step).

Specifically, when a touch gesture is made on the button K1 indicating “Lump-Sum” shown in FIG. 6B, the communication section 14 sends to the settlement server 30 at least the characters P10 of the name of a bank (for example, XYZ Bank) where the user has an account, the characters P11 of an account holder, the characters P13 of an account number, the characters T22 indicating the term “due date for payment” and the due date, and the characters T23 indicating the term “total payment” and the amount. Alternatively, when a touch gesture is made on the button K2 indicating “Installment”, the communication section 14 sends to the settlement server 30, instead of sending the above sending contents, contents containing the characters P10, P11, P13, and T22 and, in place of the characters T23, the characters T24 indicating the term “minimum installment” and the amount.

The settlement server 30 settles the electronic payment based on the received electronic payment-related characters. For example, the settlement server 30 settles the electronic payment by withdrawing an amount of payment specified by the user from a bank where the user has an account, and paying the amount of payment to the demander. Then, the settlement server 30 sends the result of the electronic payment to the communication section 14 of the information terminal 10.

Under the control of the control section 21, the display control section 29 of the information terminal 10 allows the display section 12 to display the result of the electronic payment received by the communication section 14 (S22). After S22, the control section 21 ends this processing.

As thus far described, in the first embodiment, the identification information extracting section 24 extracts, from a bill image acquired by the image acquisition section 22, identification information indicating a demander. The type determination section 25 determines the type of bill associated with the identification information extracted by the identification information extracting section 24. The region identifying section 26 reads, from the format storage section 153 previously storing individual formats of bills for individual types of bill, a format associated with the type of bill determined by the type determination section 25 and identifies, based on the read format of the bill, a region of the bill image containing character images related to an electronic payment. The character recognition section 27 recognizes characters in the region identified by the region identifying section 26. The payment information extracting section 28 extracts, among the characters in the region recognized by the character recognition section 27, characters related to an electronic payment. The display control section 29 allows the display section 12 to display the electronic payment-related characters extracted by the payment information extracting section 28. The touch panel 13 accepts from the user an instruction to make settlement with the contents of the electronic payment displayed on the display section 12. The communication section 14 sends to the settlement server 30 the electronic payment-related characters when the touch panel 13 accepts the instruction to make settlement. Therefore, the settlement server 30 can settle the electronic payment based on the sent electronic payment-related characters. Hence, such an electronic payment of a bill with no bar code can be settled. In addition, since electronic payment-related characters can be generated from various types of bill images and sent, electronic payments of various bills can be settled, which increases convenience.

The settlement system described in BACKGROUND above is required to read a bar code on a bar code-affixed bill and therefore cannot settle an electronic payment of any bill with no bar code.

Unlike the above, in this embodiment, an electronic payment of a bill with no bar code can be settled. In addition, since electronic payment-related characters can be generated from various types of bill images and sent, electronic payments of various bills can be settled, which increases convenience.

Furthermore, the user information storage section 151 previously stores credentials of each user and personal information on the user in association with each other. The user authenticating section 23 determines whether or not input information for user authentication input on the touch panel 13 agrees with the credentials stored in the user information storage section 151. When the user authenticating section 23 determines that the input information agrees with the credentials, the image acquisition section 22 acquires a bill image. In other words, only when the user's identity has been confirmed, an image of a bill charged to the user is acquired. Therefore, only the user himself/herself can give an instruction to settle an electronic payment, which ensures the safety of the electronic payment.

Moreover, the payment information extracting section 28 extracts, among the characters in the region recognized by the character recognition section 27, as the electronic payment-related characters, at least either characters related to the total payment or characters related to the amount of installment and acquires, from the user's personal information stored in the user information storage section 151, at least the characters of the name of a bank (for example, XYZ Bank) where the user has an account, the characters of an account holder, and the characters of an account number. Therefore, the user need not input electronic payment-related characters, i.e., characters related to the total payment, characters related to the amount of installment, the characters of the name of a bank where the user has an account, the characters of an account holder of the user's account, and the characters of a user's account number. Hence, an input error in electronic payment can be avoided, which ensures the safety of the electronic payment.

Furthermore, when the user authenticating section 23 determines that the input information agrees with the credentials, the image acquisition section 22 acquires a bill image captured by the image capture section 16. In other words, only when the user's identity has been confirmed, an image of a bill charged to the user is acquired. Therefore, only the user himself/herself can give an instruction to settle an electronic payment, which ensures the safety of the electronic payment.

Alternatively, when the user authenticating section 23 determines that the input information agrees with the credentials, the image acquisition section 22 acquires a bill image received by the communication section 14. In other words, only when the user's identity has been confirmed, an image of a bill charged to the user is acquired. Therefore, only the user himself/herself can give an instruction to settle an electronic payment, which ensures the safety of the electronic payment.

Furthermore, the identification information extracting section 24 includes the analysis section 241 and the identification image region identifying section 242. The analysis section 241 analyzes the layout of a bill image acquired by the image acquisition section 22. The identification information region identifying section 242 identifies an identification image region containing an identification image representing identification information in the bill image the layout of which has been analyzed by the analysis section 241. Then, the identification information extracting section 24 subjects the identification image region identified by the identification image region identifying section 242 to image recognition or character recognition, thus extracting the identification information represented by the identification image. Therefore, the user need not specify a location of an identification image in the bill image and identification information can be accurately extracted from the bill image.

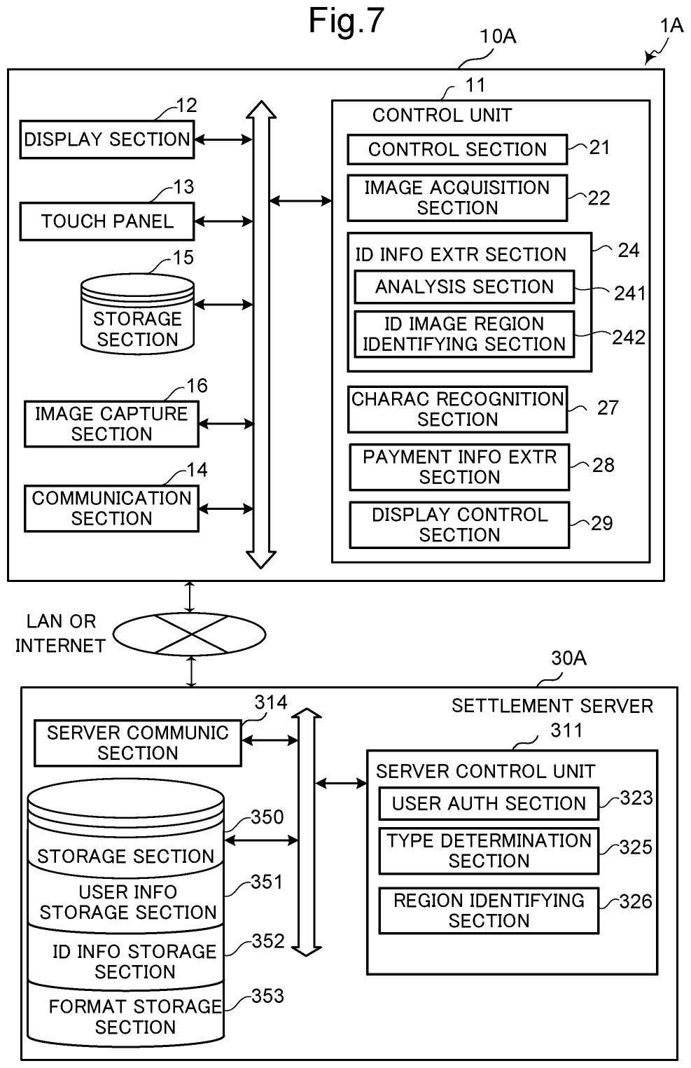

Next, a description will be given of an information processing system 1A according to a second embodiment with reference to FIG. 7. The information processing system 1A according to the second embodiment is different from the above-described information processing system 1 according to the first embodiment in that some of the functions performed by the above-described information terminal 10 according to the first embodiment are performed by a settlement server 30A.

Specifically, instead of the user authenticating section 23, the type determination section 25, and the region identifying section 26 of the information terminal 10 according to the first embodiment, a server control unit 311 of the settlement server 30A includes a user authenticating section 323, a type determination section 325, and a region identifying section 326. Instead of the user information storage section 151, the identification information storage section 152, and the format storage section 153 of the information terminal 10 according to the first embodiment, a storage section 350 of the settlement server 30A includes a user information storage section 351, an identification information storage section 352, and a format storage section 353.

The information processing system 1A according to the second embodiment is a system in which an information terminal 10A and the settlement server 30A are capable of communication with each other via a network.

The settlement server 30A includes the server control unit 311.

The server control unit 311 is composed of a processor, a RAM (random access memory), a ROM (read only memory), and so on. The processor is, for example, a CPU (central processing unit), an MPU or an ASIC. When a server control program stored in the above ROM or storage section 350 is executed by the above processor, the server control unit 311 functions as the user authenticating section 323, the type determination section 325, and the region identifying section 326. Alternatively, each of these sections of the server control unit 311 may not be implemented by the operation of the server control unit 311 in accordance with the above server control program but may be constituted by a hardware circuit.

The user authenticating section 323 determines whether or not input information for user authentication input on a touch panel 13 of the information terminal 10A and sent from the information terminal 10A agrees with the credentials stored in the user information storage section 351. When the user authenticating section 323 determines that the input information agrees with the credentials, this result of agreement is sent from a server communication section 314 of the settlement server 30A to a communication section 14 of the information terminal 10A. Then, in the information terminal 10A, the receipt of the result of agreement enables an image capture section 16 to capture an image of a bill charged to the user and an image acquisition section 22 then acquires a bill image which is an image of the bill charged to the user.

The information terminal 10A includes: an identification information extracting section 24 that extracts, from the bill image acquired by the image acquisition section 22, identification information indicating a demander; and a communication section 14 that sends to the settlement server 30A the identification information extracted by the identification information extracting section 24.

The settlement server 30A includes: the type determination section 325 that determines the type of bill associated with the identification information extracted by the identification information extracting section 24 and sent from the communication section 14; the format storage section 353 that previously stores individual formats of bills for individual types of bill; the region identifying section 326 that reads, from the format storage section 353, a format associated with the type of bill determined by the type determination section 325 and identifies, based on the read format of the bill, a region of the bill image containing character images related to an electronic payment; and the server communication section 314 that sends the region identified by the region identifying section 326 to the information terminal 10A.

The storage section 350 of the settlement server 30A includes the user information storage section 351, the identification information storage section 352, and the format storage section 353. The user information storage section 351 previously stores credentials of each user and personal information on the user in association with each other. The identification information storage section 352 previously stores identification information indicating each demander, such as a bank or a credit company. The format storage section 353 previously stores formats of bills for individual types of bill.

When the server communication section 314 receives the identification information extracted by the identification information extracting section 24 and sent from the information terminal 10A, the type determination section 325 determines, using the identification information storage section 352, the type of bill associated with the received identification information.

The region identifying section 326 reads from the format storage section 353 a format associated with the type of bill determined by the type determination section 325 and identifies, based on the read format of the bill, a region of the bill image containing character images related to an electronic payment.

When the above region is identified by the region identifying section 326, information indicating the identified region is sent from the server communication section 314 of the settlement server 30A to the communication section 14 of the information terminal 10A.

The information terminal 10A further includes: a character recognition section 27 that recognizes characters in the region sent from the server communication section 314 and received by the communication section 14; a display section 12; a payment information extracting section 28 that extracts, among the characters in the region recognized by the character recognition section 27, characters related to an electronic payment; a display control section 29 that allows the display section 12 to display the electronic payment-related characters extracted by the payment information extracting section 28; and a touch panel 13 that accepts from the user an instruction to make settlement with the contents of the electronic payment displayed on the display section 12. The communication section 14 sends the electronic payment-related characters to the settlement server 30A when the touch panel 13 accepts the instruction to make settlement.

The settlement server 30 settles the electronic payment based on the electronic payment-related characters sent from the communication section 14 and received by the server communication section 314. For example, the settlement server 30A settles the electronic payment by withdrawing an amount of payment specified by the user from a bank where the user has an account, and paying the amount of payment to the demander. The settlement server 30A sends the result of the electronic payment to the communication section 14 of the information terminal 10A.

Under the control of the control section 21, the display control section 29 of the information terminal 10A allows the display section 12 to display the result of the electronic payment received by the communication section 14.

As seen from the above, also in the second embodiment, an electronic payment of a bill with no bar code can be settled as with the first embodiment. In addition, since electronic payment-related characters can be generated from various types of bill images and sent, electronic payments of various bills can be settled, which increases convenience.

Although the description in the above embodiments has been made by taking as an example a bill to the user from a bank (ABC Bank in FIG. 5) as a demander, an electronic payment can also be settled of a bill to the user from a credit company or a bill to the user from a store, a service provider or the like.

The structures, configurations, and processing described in the above embodiments with reference to FIGS. 1 to 7 are merely illustrative of the present disclosure and the present disclosure is not intended to be limited to the above structures, configurations, and processing.

While the present disclosure has been described in detail with reference to the embodiments thereof, it would be apparent to those skilled in the art the various changes and modifications may be made therein within the scope defined by the appended claims.

What is claimed is:

1. An information processing device comprising:
a display section;
a format storage section that previously stores formats of bills for individual types of bill;
a control unit that comprises a processor and, upon execution of a control program by the processor, functions as
an image acquisition section that acquires a bill image which is an image of a bill charged to a user,
an identification information extracting section that extracts, from the bill image acquired by the image acquisition section, identification information indicating a demander,
a type determination section that determines a type of bill associated with the identification information extracted by the identification information extracting section,
a region identifying section that reads from the format storage section a format associated with the type of bill determined by the type determination section and identifies, based on the read format of the bill, a region of the bill image containing character images related to an electronic payment,
a character recognition section that recognizes characters in the region identified by the region identifying section,
a payment information extracting section that extracts, among the characters in the region recognized by the character recognition section, characters related to the electronic payment, and
a display control section that allows the display section to display the electronic payment-related characters extracted by the payment information extracting section;
an operating section that accepts from the user an instruction to make settlement with contents of the electronic payment displayed on the display section; and
a communication section that sends to a settlement server the electronic payment-related characters when the operating section accepts the instruction to make settlement.

2. The information processing device according to claim 1,
further comprising a user information storage section that previously stores credentials of each user and personal information on the user in association with each other,
wherein, upon execution of the control program by the processor, the control unit further functions as a user authenticating section that determines whether or not input information for user authentication input through the operating section agrees with the credentials stored in the user information storage section, and
wherein when the user authenticating section determines that the input information agrees with the credentials, the image acquisition section acquires the bill image.

3. The information processing device according to claim 2, wherein the payment information extracting section extracts, among characters in the region recognized by the character recognition section, as the electronic payment-related characters, at least either characters related to a total payment or characters related to an amount of installment and acquires, from the user's personal information stored in the user information storage section, at least characters of a name of a bank where the user has an account, characters of an account holder, and characters of an account number.

4. The information processing device according to claim 2,
further comprising an image capture section that captures an image of the bill,
wherein when the user authenticating section determines that the input information agrees with the credentials, the image acquisition section acquires the bill image captured by the image capture section.

5. The information processing device according to claim 2,
wherein the communication section receives the bill image, and
wherein when the user authenticating section determines that the input information agrees with the credentials, the image acquisition section acquires the bill image received by the communication section.

6. The information processing device according to claim 1, wherein the identification information extracting section comprises: an analysis section that analyzes a layout of the bill image acquired by the image acquisition section; and an identification image region identifying section that identifies an identification image region containing an identification image representing the identification information in the bill image the layout of which has been analyzed by the analysis section, and the identification information extracting section subjects the identification image region identified by the identification image region identifying section to image recognition or character recognition, thus extracting the identification information represented by the identification image.

7. The information processing device according to claim 1, wherein the region identifying section uses layout information contained in the read format of the bill to identify the region of the bill image containing character images related to an electronic payment.

8. An information processing method comprising:
an image acquisition step of acquiring a bill image which is an image of a bill charged to a user;
an identification information extracting step of extracting identification information indicating a demander from the bill image acquired in the image acquisition step;
a type determination step of determining a type of bill associated with the identification information extracted in the identification information extracting step;
a region identifying step of reading, from a format storage section previously storing formats of bills for individual types of bill, a format associated with the type of bill determined in the type determination step and identifying, based on the read format of the bill, a region of the bill image containing character images related to an electronic payment;
a character recognizing step of recognizing characters in the region identified in the region identifying step;
a payment information extracting step of extracting, among the characters in the region recognized in the character recognizing step, characters related to the electronic payment;
a display control step of allowing the display section to display the electronic payment-related characters extracted in the payment information extracting step;
an operating step of accepting from the user an instruction to make settlement with contents of the electronic payment displayed on the display section; and
a communication step of, upon acceptance of the instruction to make settlement in the operating step, sending the electronic payment-related characters to a settlement server.

9. An information processing system in which an information processing device and a settlement server are capable of communication with each other via a network,
the information processing device comprising:
a control unit that comprises a processor and, upon execution of a control program by the processor, functions as
an image acquisition section that acquires a bill image which is an image of a bill charged to a user, and
an identification information extracting section that extracts, from the bill image acquired by the image acquisition section, identification information indicating a demander; and
a communication section that sends to the settlement server the identification information extracted by the identification information extracting section,
the settlement server comprising:
a format storage section that previously stores formats of bills for individual types of bill;
a server control unit that comprises a processor and, upon execution of a server control program by the processor, functions as
a type determination section that determines a type of bill associated with the identification information having been extracted by the identification information extracting section and having been received from the communication section, and
a region identifying section that reads from the format storage section a format associated with the type of bill determined by the type determination section and identifies, based on the read format of the bill, a region of the bill image containing character images related to an electronic payment; and
a server communication section that sends to the information processing device the region identified by the region identifying section,
wherein the information processing device further comprises a display section,
wherein, upon execution of the control program by the processor, the control unit further functions as:
a character recognition section that recognizes characters in the region sent from the server communication section and received by the communication section;
a payment information extracting section that extracts, among the characters in the region recognized by the character recognition section, characters related to the electronic payment; and
a display control section that allows the display section to display the electronic payment-related characters extracted by the payment information extracting section,
wherein the information processing device further comprises an operating section that accepts from the user an instruction to make settlement with contents of the electronic payment displayed on the display section,
wherein when the operating section accepts the instruction to make settlement, the communication section sends the electronic payment-related characters to the settlement server, and
wherein the settlement server settles the electronic payment based on information indicated by the electronic payment-related characters sent from the communication section and received by the server communication section.
